(19) United States
(12) Patent Application Publication
(10) Pub. No.: US 2024/0169201 A1
(43) Pub. Date: May 23, 2024

(54) MICROCONTROLLER UNIT INTEGRATING AN SRAM-BASED IN-MEMORY COMPUTING ACCELERATOR

(71) Applicant: THE TRUSTEES OF COLUMBIA UNIVERSITY IN THE CITY OF NEW YORK, New York, NY (US)

(72) Inventors: Mingoo Seok, Tenafly, NJ (US); Chuan-Tung Lin, New York, NY (US)

(73) Assignee: THE TRUSTEES OF COLUMBIA UNIVERSITY IN THE CITY OF NEW YORK, New York, NY (US)

(21) Appl. No.: 18/495,427

(22) Filed: Oct. 26, 2023

Related U.S. Application Data
(60) Provisional application No. 63/427,599, filed on Nov. 23, 2022.

(51) Int. Cl. G06N 3/08; G06N 3/04

(52) U.S. Cl. CPC G06N 3/08; G06N 3/04

(57) ABSTRACT

Microcontroller units and methods for computing performance are provided. The disclosed microcontroller unit can include a central processing unit (CPU) configured to start a computing program, an accelerator comprising an in-memory computing (IMC) macro cluster configured to accelerate at least one layer of a machine learning model, a data memory (DMEM), and a direct memory access (DMA) module configured to transfer a weight data of a layer of a machine learning model from the DMEM to the IMC macro cluster.

### CROSS-REFERENCE TO RELATED APPLICATION

This application claims priority to U.S. Provisional Patent Application Ser. No. 63/427,599, filed Nov. 23, 2022, which is hereby incorporated by reference herein in its entirety.

### STATEMENT REGARDING FEDERALLY SPONSORED RESEARCH

This invention was made with government support under grant number 1919147 awarded by the National Science Foundation (NSF). The government has certain rights in the invention.

### BACKGROUND

The advancements in machine learning (ML) can allow ultra-low-power microcontroller units (MCUs) with limited power and memory budget to perform ML tasks at the edge. Tiny machine learning (TinyML), which aims to collect data, execute ML models, and analyze the data in real-time on ultra-low-power devices near sensors, provides critical benefits, such as security and privacy. TinyML can also reduce latency and extend the battery life by avoiding the cost of transmitting data over wireless communication.

The intensive computation required by ML inference motivates research in specialized hardware design. SRAM-based in-memory computing (IMC) can improve energy efficiency and throughput in vector-matrix multiplication (VMM), which can be a dominant kernel in ML inference. Certain digital accelerator architecture requires accessing data in on-chip SRAM, one row at a time, which limits the throughput and energy efficiency. On the other hand, by combining the memory cells and computation elements inside a memory array/macro, IMC can perform many multiply-and-accumulate (MAC) operations without the row-by-row accesses, simultaneously enabling higher parallelism, throughput, and energy efficiency.

Certain IMC-based MCUs at the time of filing employ analog-mixed-signal (AMS) IC macros, which use capacitors and resistors for computation and ADCs for analog-to-digital conversion (ADC). AMS IC is capable of achieving high energy efficiency and area efficiency. However, analog hardware can cause incorrect VMM results over process, voltage, and temperature (PVT) variations, thereby degrading the accuracy of the ML model. Digital IMC hardware, on the contrary, uses digital arithmetic circuits, such as compressors, adders, and accumulators, performing MAC operations robustly across PVT variations. Digital IMC hardware tends to consume more silicon area.

On the other hand, in developing an MCU, its hardware and software stack to bring ML tasks need to be co-optimized to resource-constrained devices efficiently. A workflow to port ML models onto MCUs includes model development (data engineering, model selection, and hyper-parameter tuning/neural architecture search) and model deployment (software suite, model compression, and code generation). For instance, TensorFlow Lite for microcontrollers (TFLite-micro) can optimize TensorFlow models and convert the model file into a reduced-size binary file with less complexity.

Accordingly, there exists a need for methods and systems that can address such limitations.

### SUMMARY

Microcontroller units and methods for computing performance are provided.

An example microcontroller unit can include a central processing unit (CPU) configured to start a computing program, an accelerator, a data memory (DMEM), and a direct memory access (DMA) module configured to transfer a weight data of a layer of a machine learning model from the DMEM to the IMC macro cluster. In non-limiting embodiments, the accelerator can include an in-memory computing (TMC) macro cluster configured to accelerate at least one layer of a machine-learning model.

In certain embodiments, the accelerator can include a microarchitecture configured to support a fully pipelined operation.

In certain embodiments, the microarchitecture of the accelerator can include a first stage, a second stage, and a third stage. In non-limiting embodiments, the first stage can be configured to prepare an input vector and feed it to the second stage, wherein the first stage is configured to employ buffers operating in a ping-pong fashion to hide latency. The first stage can include a scratchpad which can store the deep neural network (DNN) input/output data and an input ping-pong buffer that can fetch specific parts of data from the scratchpad based on the DNN layer parameters and send the data into the next stage. In non-limiting embodiments, the second stage can be configured to perform a vector-matrix multiplication (VMM) using the IMC macro cluster. The second stage can include an IMC macro cluster, an adder tree, a latch, and a weight buffer. The IMC macro cluster can be configured to complete a multiplication in 64 cycles. The adder tree can add the partial sums from four IMC macros and the latch can store the results before feeding the results to the next stage. The weight buffer can be a buffer memory to prepare the data to be written into one row of IMC macros. In non-limiting embodiments, the third stage can be configured to perform quantization based on results from the second stage. The third stage can include a 23 b adder, 64 b multiplier, shifter, and memory for bias, shift, and multiplier. The stage can support the TFLite-micro quantization scheme which can quantize the data from 25 b to 8 b before storing the data to the scratchpad. The bias, shift, and multiplier memory can store layer-dependent bias, shift, and multiplier parameters.

In certain embodiments, the IMC macro cluster can include a timesharing architecture. The IMC macro cluster can include 6 T bitcells that can be configured to share multiplication units.

In certain embodiments, the IMC macro cluster can include a lock clock generator. The lock clock generator can be configured to produce a clock signal for the accelerator when a task is given to the accelerator. When the accelerator completes the task, the lock clock resets a start bit to stop the clock.

In certain embodiments, the DMEM can be implemented in foundry 6 T bitcells and configured to store all weight data.

In certain embodiments, the microcontroller unit can be an in-memory computing (IMC) based microcontroller unit.

In certain embodiments, the microcontroller unit can include an instruction memory (TMIEM), which can store the program of the DNN model to be fetched an executed by the host; an universal asynchronous receiver-transmitter (UART) that can transmit and receive data between two hardware devices; a general-purpose IO (GPIO) that can be used to perform digital input or output functions controlled by the software; and a bus that can connect the CPU, memory, and the input/output devices, carrying data, address, and control information.

In certain embodiments, a size of the IMC size can be up to 32 KB. In non-limiting embodiments, a size of the in-accelerator scratch pad can be up to 48 KB. In non-limiting embodiments, a total area of the microcontroller unit can be less than about 2.03 mm².

The disclosed subject matter provides methods for producing a software framework. An example method can include producing a TensorFlow (TF) file by training a deep neural network (DNN) model; converting the TF file into a TensorFlow Lite (TFLite) file and fusing a batch norm layer of the DNN model into a convolution layer; converting the TFLite file to a C header file; producing an instruction file and a data hexadecimal file by compiling the C header file with an input data file and a TFLite-micro library file; and producing software for the DNN model using the instruction file and the data hexadecimal file.

In certain embodiments, the DNN model can be an 8-b DNN model. In non-limiting embodiments, the instruction and the date hexadecimal file are stored in IMEM and DMEM.

### BRIEF DESCRIPTION OF THE DRAWINGS

FIG. 1 provides a diagram showing an example iMCU microarchitecture in accordance with the disclosed subject matter.

FIG. 2 provides a diagram showing an example software framework for iMCU in accordance with the disclosed subject matter.

FIG. 3 provides a diagram showing an example neural network models: ResNetv1, tiny-embedding-cony, and tiny conv (16C3: 16 features 3×3 convolution, AP8: 8×8 average pooling, FC10: 10 fully connected) in accordance with the disclosed subject matter.

FIG. 4 provides a diagram showing an example of workload profiling results of tiny-conv and ResNetv in accordance with the disclosed subject matter.

FIG. 5 provides a graph showing the latency improvement estimation in accordance with the disclosed subject matter.

FIG. 6A provides a graph showing that the disclosed computation flow enables 5× area reduction at the 23% latency penalty. FIG. 6B provides a graph showing the latency for convolution and addition layers for different scratchpad and IMC sizes.

FIG. 7 provides a diagram showing an example computation flow and the memory map of iMCU in accordance with the disclosed subject matter.

FIG. 8 provides a graph showing an example size of the IMC macro cluster, the in-accelerator scratch pad, and the DMEM to support the target workloads based on the disclosed computation flow in accordance with the disclosed subject matter.

FIG. 9A provides graphs showing an example block diagram in accordance with the disclosed subject matter. FIG. 9B provides graphs showing an example data transfer from DMEM to IMC cluster of orthogonal and parallel versions of IMC in accordance with the disclosed subject matter.

FIG. 10 provides a graph showing an example interference latency across different IC and host clock speeds in accordance with the disclosed subject matter.

FIG. 11 provides a graph showing an example of simulated latency of convolution and addition layers and bus power consumption across different bus widths in accordance with the disclosed subject matter.

FIG. 12 provides a graph showing an example speedup and the number of weight reuses of each convolution layer in ResNetv1 in accordance with the disclosed subject matter.

FIG. 13 provides a graph showing an example of low utilization in layers in ResNetv1 in accordance with the disclosed subject matter.

FIG. 14 provides a diagram showing an example IMC accelerator microarchitecture in accordance with the disclosed subject matter.

FIG. 15 provides a diagram showing an example architecture of a 128×128 digital IMC macro in accordance with the disclosed subject matter.

FIG. 16 provides a diagram showing an example die micrograph in accordance with the disclosed subject matter.

FIG. 17A provides a graph showing an example measured latency in accordance with the disclosed subject matter. FIG. 17B provides a graph showing an example energy consumption across different supply voltages in accordance with the disclosed subject matter.

FIG. 17C provides a graph showing an example latency and energy consumption across different temperatures in accordance with the disclosed subject matter.

FIG. 18 provides diagrams showing an example latency, energy, and area breakdown of IMCU in accordance with the disclosed subject matter.

FIG. 19 provides graphs showing an example maximum throughput, energy efficiency, and leakage power of 15 dies at 0.7V supply in accordance with the disclosed subject matter.

FIG. 20 provides a graph showing an example energy-delay product and SRAM size of MCUs in accordance with the disclosed subject matter.

FIG. 21 provides a diagram showing an example iMCU ship architecture and software framework in accordance with the disclosed subject matter.

FIG. 22 provides a diagram showing an example neural network models in accordance with the disclosed subject matter.

FIG. 23 provides a diagram showing an example computation flow and memory map of the disclosed iMCU in accordance with the disclosed subject matter.

FIG. 24 provides a diagram showing an example IC accelerator microarchitecture in accordance with the disclosed subject matter.

FIG. 25 provides diagrams and graphs showing measurement results (i.e., latency and energy consumption of iMCU over supply voltages) in accordance with the disclosed subject matter.

FIG. 27 provides a diagram showing an example IC orientation in accordance with the disclosed subject matter.

The accompanying drawings, which are incorporated and constitute part of this disclosure, illustrate certain embodiments and serve to explain the principles of the disclosed subject matter.

### DETAILED DESCRIPTION

Reference will now be made in detail to the various exemplary embodiments of the disclosed subject matter, which are illustrated in the accompanying drawings.

The terms used in this specification generally have their ordinary meanings in the art, within the context of the disclosed subject matter, and in the specific context where each term is used. Certain terms are discussed below, or elsewhere in the specification, to provide additional guidance in describing the disclosed subject matter.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As disclosed herein, vector matrix multiplication (VMM) is a computational extensive kernel in machine learning applications. 8-b DNN is a DNN model that has quantized 8-bit precision for inputs, weights, and outputs. TensorFlow is a publicly-available, open-source software library for machine learning. TensorFlow Lite is a set of tools that can enable running DNN models on embedded and edge devices. A C header file is a text file that includes code written in the C programming language.

The disclosed subject matter provides techniques for computing performance. The disclosed subject matter provides systems and methods for computing performance. The disclosed systems can include microcontroller units. An example microcontroller unit can include a central processing unit (CPU), an accelerator, a data memory (DMEM), a direct memory access (DMA) module, a universal asynchronous receiver-transmitter (UART), a general-purpose IO (GPIO), a bus, or combinations thereof.

In certain embodiments, the disclosed CPU can be configured to start a computing program as a host processor. The CPU can perform small workload such as activation layers in a DNN model and can control the IMC accelerator and peripherals. In non-limiting embodiments, the disclosed CPU can be a set of electronic circuitry that runs the disclosed techniques and methods for computing performance. For example, the CPU can be a 32 b RISC-V CPU core (host processor).

In certain embodiments, the disclosed accelerator can include an in-memory computing (IMC) macro cluster configured to accelerate at least one layer of a machine-learning model. In non-limiting embodiments, the accelerator can have a microarchitecture that supports the computation flow in a fully pipelined manner. For example, the microarchitecture of the accelerator can have stages (e.g., each designed to take the same 64 cycles for the fully-pipelined operation). The first stage can include a scratchpad which can store the DNN input/output data and an input ping-pong buffer that can fetch specific parts of data from the scratchpad based on the DNN layer parameters and send the data into the next stage. The second stage can include an IMC macro cluster, an adder tree, a latch, and weight buffer performing VMM operations. The adder tree can add the partial sums from four IMC macros and the latch can store the results before feeding the results to the next stage. The weight buffer can be a buffer memory to prepare the data to be written into one row of IMC macros. The third stage can include a 23 b adder, 64 b multiplier, shifter, and memory for bias, shift, and multiplier. The third stage can support the TFLite-micro quantization scheme which can quantize the data from 25 b to 8 b before storing the data to the scratchpad. The bias, shift, and multiplier memory can store layer-dependent bias, shift, and multiplier parameters.

In certain embodiments, the first stage (e.g., INVEC), which can include a scratchpad which stores the DNN input/output data and an input ping-pong buffer that fetches specific parts of data from scratchpad based on the DNN layer parameters can prepare input vectors and feed them to the next stage. It can employ two 512B buffers operating in a ping-pong fashion to hide the latency. One buffer can grab 8 B data per cycle from the scratchpad over 64 cycles. In parallel, the other buffer can feed an input vector, again 8B per cycle, to the IMC macro cluster. In non-limiting embodiments, the first stage (e.g., INVEC) can include a scratch pad and input ping-pong buffer. The scratchpad can be SRAM memory that can store intermediate input and output data during a DNN. The input buffers can be buffer memory to fetch certain data from the scratchpad based on the DNN layer parameters such as filter width, height, and padding size.

In certain embodiments, the second stage (e.g., IMC, which can include an IC macro cluster, an adder tree, a latch, and a weight buffer) can perform VMM using the 4×4 IMC macro cluster. The cluster can complete one multiplication between an 8 b 512d (dimension) vector and an 8 b 64×512d matrix in 64 cycles. In non-limiting embodiments, the digital IC macro cluster can be configured to maximize robustness while trying to reduce the area overhead of digital circuits. For example, the disclosed IC macro cluster can have a timesharing architecture, where the macro can employ 128×128 compact 6 T bitcells to store the NN weights. As used herein, NN weights can be real values that can control the strength of the connection between two neurons in a DNN. In non-limiting embodiments, every eight bitcells can share two multiplication units, which are implemented as NOR gates, and every 128×8 bitcells can timeshare a set of compressors and an adder tree, which results in an excellent weight density of 126 KB/mm². As used herein, timeshare can include sharing of computing resources (compressors and adder tree) among many bitcells across time, reducing the overhead of hardware resources. The macro can provide improved compute density (e.g., 1.25 TOPS/mm² at 1V) and energy efficiency (e.g., 40.16 TOPS/W at 0.6V with a 25% input toggle rate). In non-limiting embodiments, after the inverted inputs perform multiplication with the inverted weights, the results of one column can be fed into a compressor to produce the compressed results. For example, the 15-4 compressor can convert 15 unweighted (2⁰) bits into weighted (2⁰-2³) bits. In non-limiting embodiments, the adder tree and shift-accumulator can take the partial sums and accumulate in a bit-serial manner for 8 b input and 8 b weight. In non-limiting embodiments, the second stage can include a weight buffer, the IMC cluster, an adder tree, and a latch. The weight buffer can be a buffer memory to prepare the data to be written into one row of IMC macros. The latch can be a memory to store the results from IMC macros before feeding them to the next stage. The disclosed microcontroller can include digital circuits, including compressors and adders, to ensure high robustness over process, voltage, and temperature (PVT) variations.

In certain embodiments, the third stage (e.g., QUAN, which can include a 32 b adder, 64 b multiplier, shifter, and memory for bias, shift, and multiplier) can perform the quantization. For example, the IMC stage's result can have up to 25 bits but can be quantized to 8 b before storing them in the scratchpad. The quantized value q can be defined as:

q=2ⁿ·M₀·(r+Z) (1)

where n, M₀₇, and Z are offline-computed hyperparameters, and r is the IMC stage's result. In non-limiting embodiments, to quantize a 64d vector in 64 cycles, QUAN can employ one 2-input 32 b adder, one 2-input 64 b multiplier, and one 32 b-shifter.

In certain embodiments, the IMC macro cluster can include a lock clock generator. The lock clock generator can be configured to produce a clock signal for the accelerator when a task is given to the accelerator. For example, when the accelerator completes the task, the lock clock can reset a start bit to stop the clock. In the course of performing an end-to-end inference, the accelerator can be active only for a part of the time. The host can set the Start bit in the configuration register file to enable the clock generator. When the accelerator completes a given task, it resets the Start bit to stop the clock. This on-demand clock generation can reduce unnecessary clock power waste.

In certain embodiments, the size of the IMC size can be up to about 32 KB. In non-limiting embodiments, the size of the in-accelerator scratch pad can be up to about 48 KB. In non-limiting embodiments, a total area of the microcontroller unit can be less than about 2.03 mm².

In certain embodiments, the microcontroller unit can include DMEM, which can store software variables and DNN data; an instruction memory (IMEM), which can store the program of the DNN model to be fetched and executed by the host; a universal asynchronous receiver-transmitter (UART) that can transmit and receive data between two hardware devices; a general-purpose IO (GPIO), which can be used to perform digital input or output functions controlled by the software; and a bus that can connect the CPU, memory, and the input/output devices, carrying data, address, and control information. In non-limiting embodiments, the IC can be configured to be an orthogonal structure or a parallel structure. MAC wordline (MWL) can be orthogonal to WL in the orthogonal structure, while MWL can be parallel to WL in the parallel structure of IMC. MWL can be a separate wire that can enable and read out a row of bitcell data for IMC multiply and accumulate operations. In the orthogonal structure, the DMA can be configured to write the data into IMC with the same continuous address order as in the DMEM since the IO buffer and the weight buffer can be in the same direction. In the parallel structure, there can be an offset for writing the weight data from DMEM to IMC. As this irregular address pattern can make transferring the data difficult for the DMA for weight data movement in a continuous address from DMEM to IMC, the disclosed custom compilation method can transpose the weight data offline before loading it into the DMEM.

In certain embodiments, the disclosed DMEM can be implemented in foundry 6 T bitcells and configured to store all weight data. To allow the IC accelerator can buffer only one layer at a time, the IMC size can be up to 32 KB, roughly matched to the largest layer of the target models. DMEM size can be up to 256 KB. In non-limiting embodiments, the scratch pad in the accelerator can fully buffer the output of one layer so that it can be used as the next layer's input. This feature can allow to avoid costly DMEM accesses. In non-limiting embodiments, the scratchpad size can be up to 48 KB, and the size of IMEM can be up to 128 KB to store the largest program.

In certain embodiments, the microcontroller unit can be an in-memory computing (IMC) based microcontroller unit. For example, the IMC-based MCU (iMCU) can be in the form of a 28 nm CMOS. In non-limiting embodiments, the disclosed iMCU can outperform the neural MCU by 73× in the FoM=accelerator compute density×accelerator energy efficiency×IMC density. Employing only a small amount of IMC hardware, it also achieves a compact footprint of 2.73 mm² and 4.7× higher SRAM density than certain IMC-based MCU.

The disclosed subject matter provides methods for producing a software framework. An example method can include producing a TensorFlow (TF) file by training a deep neural network (DNN) model; converting the TF file into a TensorFlow Lite (TFLite) file and fusing a batch norm layer of the DNN model into a convolution layer; converting the TFLite file to a C header file; producing an instruction file and a data hexadecimal file by compiling the C header file with an input data file and a TFLite-micro library file; and producing software for the DNN model using the instruction file and the data hexadecimal file. For example, the method can start with training an 8-b DNN model via TensorFlow, which produces a TF file. Then, the TF file can be converted into the TFLite file by fusing a batch norm layer into a convolution layer. This can help to avoid adding explicit hardware support for batch-norm-related computation. Then, the TFLite file can be converted to the C header file model.cc., and the header file can be compiled with the input data file (input.cc) and the TFLite-micro library file. In non-limiting embodiments, the compilation can produce the instruction and data hexadecimal files, which can be stored in IMEM and DMEM.

In certain embodiments, using the disclosed methods or framework, software for the DNN models (e.g., tiny-cony, tiny-embedding-cony, and ResNetv1) can be developed.

### EXAMPLES

### Example 1: iMCU: A 28 nm Digital In-Memory Computing-Based Microcontroller Unit for Edge TinyML

In this example, the disclosed subject matter provides a digital IMC-based MCU, titled iMCU, which integrates a 32-b RISC—V-based MCU with a digital IMC accelerator. The iMCU is designed to improve energy efficiency, latency, and silicon area. Acceleration targets can be optimally selected, and an area-efficient computation flow that requires the least amount of additional hardware yet still provides a significant acceleration is devised. The digital IMC circuits (titled D6CIM) and a fully-pipelined accelerator based on them are developed. In this example, the performance of iMCU while sweeping various microarchitecture parameters such as IMC sizes, scratchpad sizes, bus widths, and clock speeds was assessed.

Here, the iMCU was produced in a 28 nm CMOS. The measurement results show that iMCU significantly outperforms the best neural MCU by 73× in the FoM=accelerator compute density×accelerator energy efficiency×IMC density. Employing only a small amount of IMC hardware, it also achieves a compact footprint of 2.73 mm² and 4.7× higher SRAM density than the prior state-of-the-art IMC-based MCU.

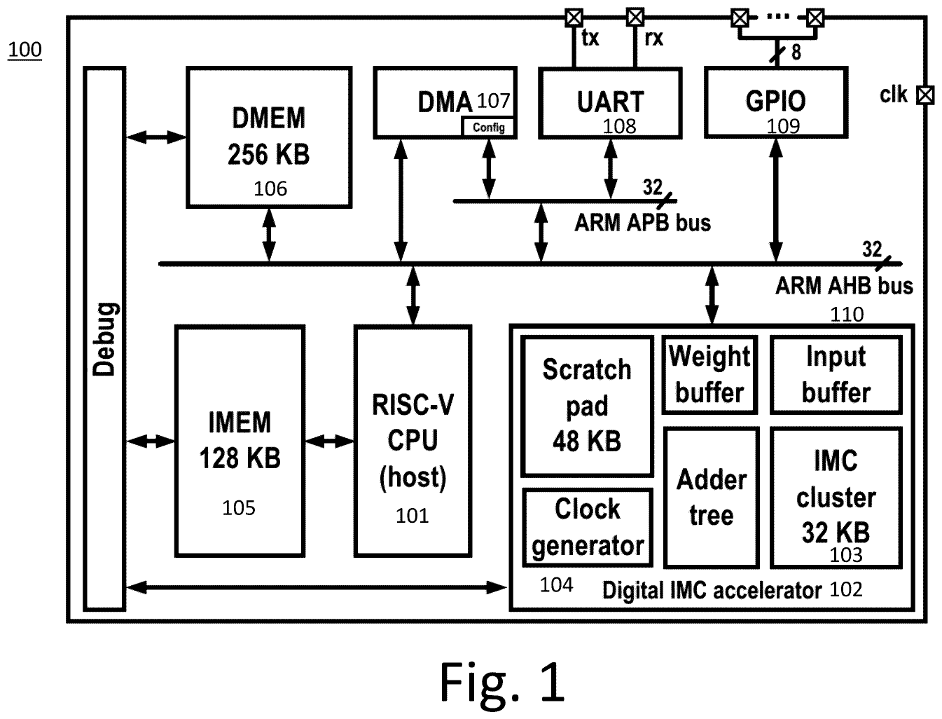

Hardware Architecture And Software Development Framework: FIG. 1 details the overall organization of iMCU 100, which consists of i) a 32 b RISC-V CPU core (host processor) 101, ii) a digital IMC accelerator 102 which contains the IMC macro cluster 103 and a lock clock generator 104, iii) instruction memory (IMEM) 105, iv) data memory (DMEM) 106, v) a direct memory access (DMA) module 107, vi) a universal asynchronous receiver-transmitter (UART) 108, vii) a general-purpose IO (GPIO) 109, and viii) a 32 b ARM AHB/APB bus 110.

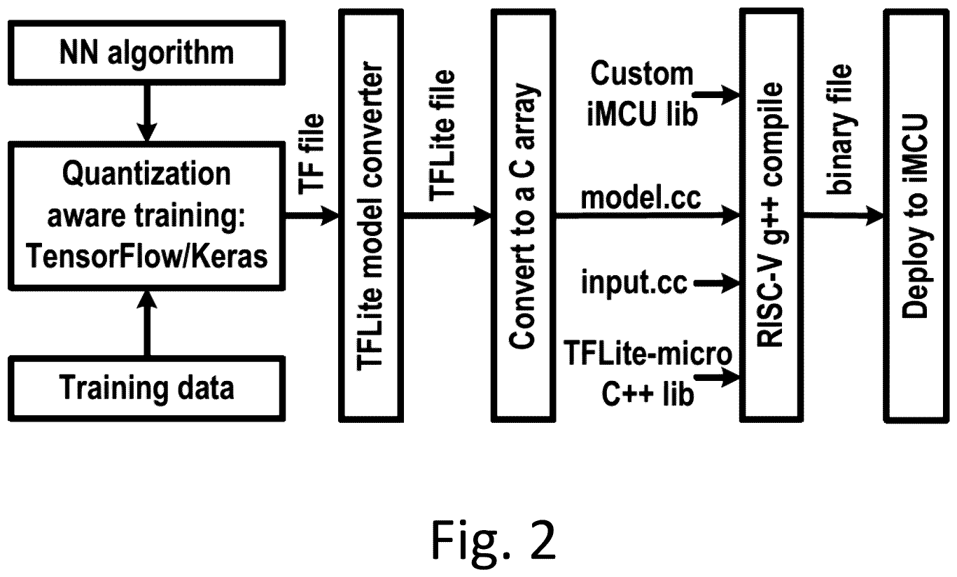

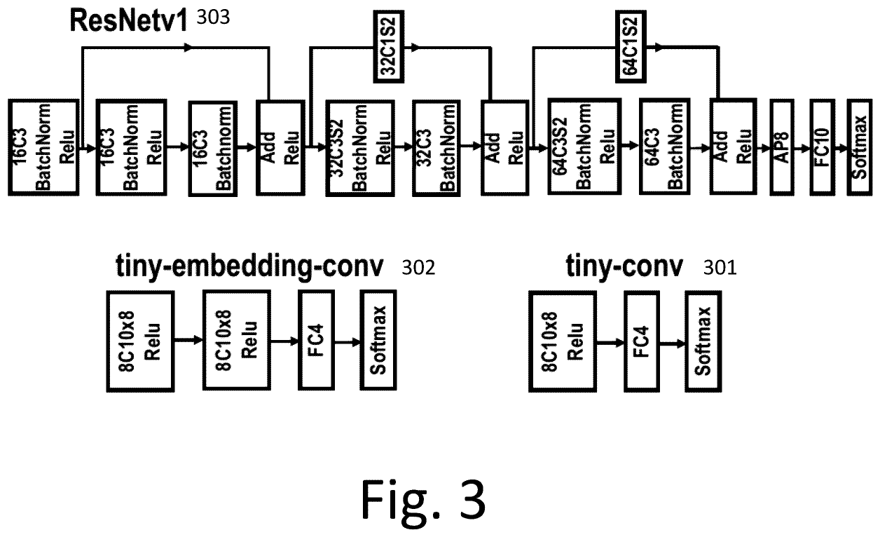

FIG. 2 shows the matching software development framework for iMCU. It starts with training an 8-b DNN model via TensorFlow, which produces a TF file. Then, the TF file was converted into the TFLite file by fusing a batch norm layer into a convolution layer. This helps to avoid adding explicit hardware support for batch-norm-related computation. The TFLite file was then converted to the C header file model cc. Then, the header file was compiled with the input data file (input.cc) and the TFLite-micro library file. The compilation produces the instruction and data hexadecimal files, which are stored in IMEM and DMEM. Using the framework, the software was developed for the following DNN models, tiny-conv 301, tiny-embedding-cony (both from TFLite-micro) 302, and ResNetv1 303 (from MLPerf-Tiny, an open-source benchmark suite, which provides a set of DNNs in C++ to evaluate MCUs) (FIG. 3). ResNetv1 achieves 86.96% on CIFAR-10; tiny-conv achieves 91.34% on GSCD (4 keywords).

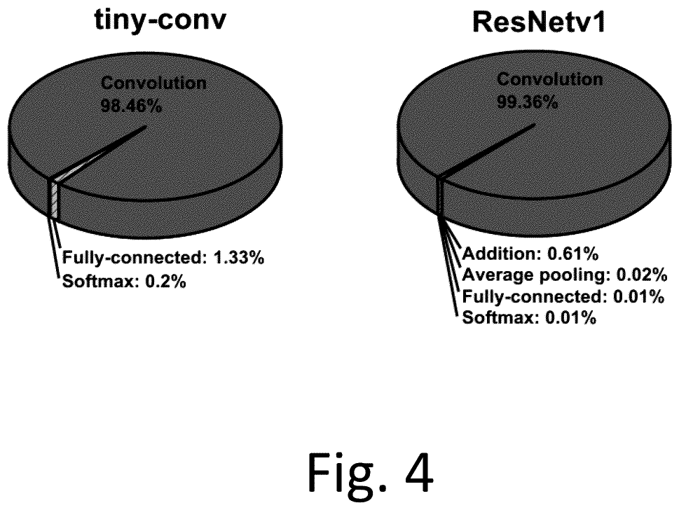

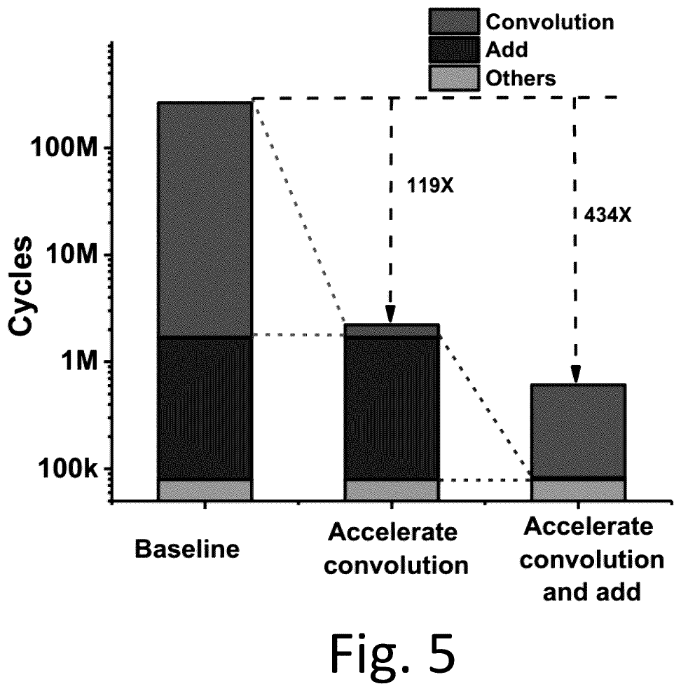

Workload Profiling and Division: the disclosed iMCU was designed by identifying the DNN workload worth acceleration so that minimal hardware can be incorporated in the accelerator to support those layers only. The computation complexity of each layer was profiled using SPIKE (a RISC-V simulator). The convolution layer is the most dominant, followed by the addition layer (FIG. 4). From this data, if convolution layers were accelerated by 500×, the total cycle count can be reduced by 119×. If additional layers were accelerated as well, an additional 3.6× speed-up (total 434×) can be gained (FIG. 5). All the other layers (pooling, fully connected, softmax) are not worth accelerating since accelerating them provides only a negligible cycle count reduction.

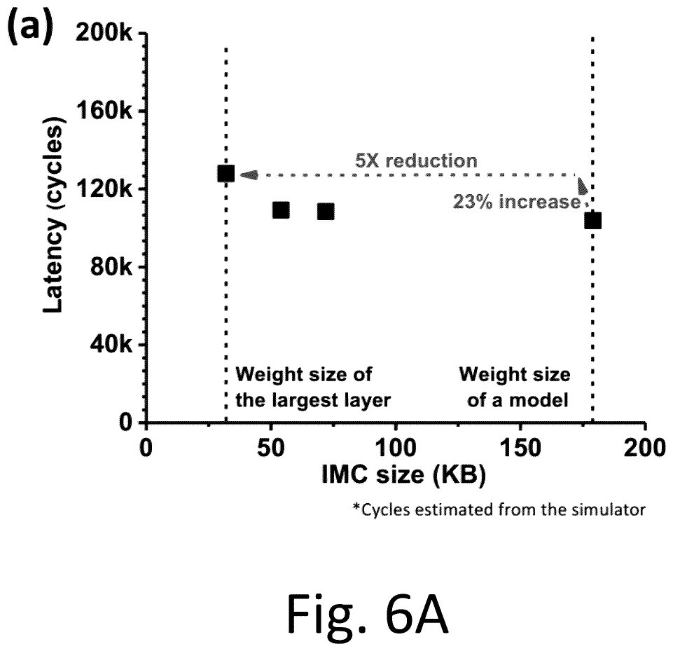

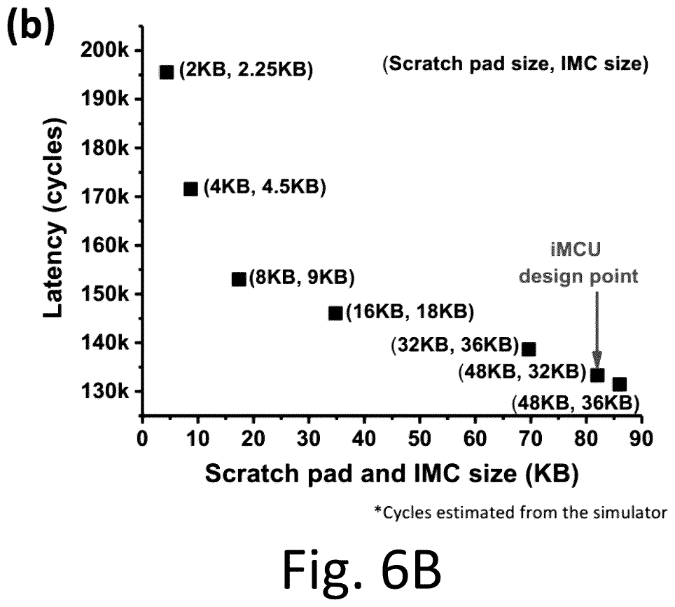

Area-Efficient Computation Flow: the computation flow (sequence) that requires the least amount of IMC hardware yet still delivers a significant acceleration was developed. Certain systems and methods employ arbitrarily large amounts of IMC hardware to store more than one (potentially all) layer of weight data of a DNN model before starting computation. Such architecture, however, severely increases area overhead since IMC hardware is generally large. Here, an alternative flow was devised where DMEM, implemented in the dense foundry 6 T bitcells, stores all the weights. The IMC hardware buffers the weight data of only one layer right before the accelerator computes the layer. This can largely save the area of the IMC hardware but increase data movement costs between DMEM and IMC hardware. However, the area savings largely outweigh the cost: it reduces the IMC hardware's area by 5× at a 23% increase in the cycle count (FIG. 6(a)). This is because 100-10,000 VMMs were performed for each layer, thereby amortizing the data movement cost over those many VMMs.

The latency was estimated for various sizes to analyze the impact with a limited scratch pad and IMC cluster sizes (FIG. 6(b)). The increase in latency comes in two parts. If there is a smaller IMC size than the necessary IMC size, the same inputs need to be computed twice for different weights. In addition, if there is a limited scratchpad size that is insufficient for storing the output data of one layer, there can be latency overhead to transfer the temporary input/output activation between the main and scratchpad memory.

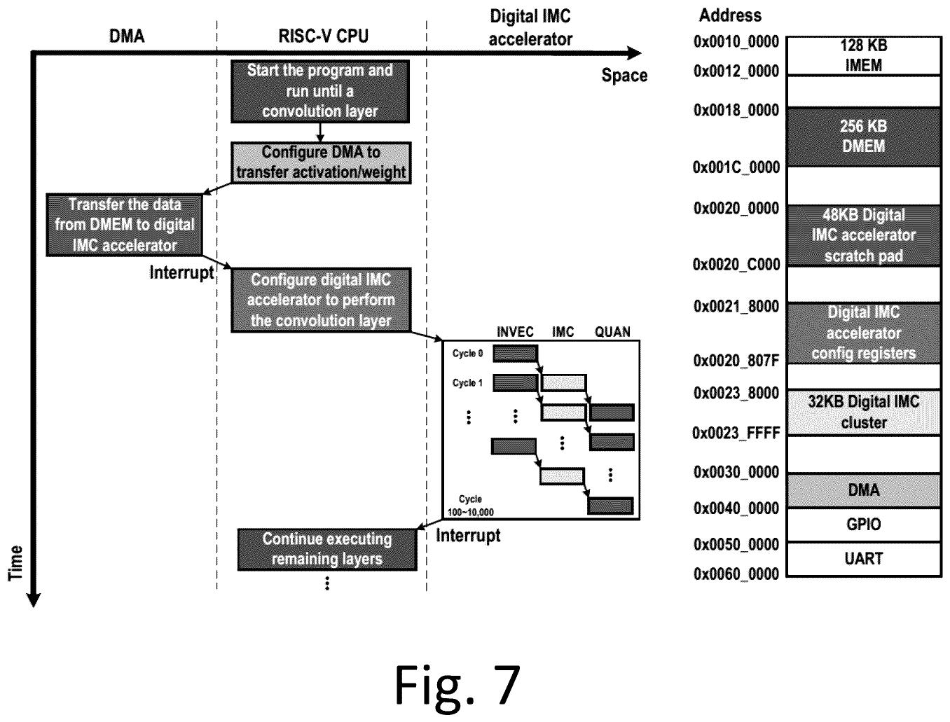

FIG. 7 shows the proposed computation flow for an end-to-end inference. First, the host starts the program. When it reaches a convolution (or an addition layer), it configures DMA to transfer the weight data of a layer from DMEM to the IMC cluster; and the input data from DMEM to the scratchpad (only for the input layer). Upon the data transfer, the host configures layer-related parameters such as input, filter, and output dimensions, stride and padding sizes, input and output offsets, and the starting addresses of the input, weight, output data accesses, etc. Also, the host configures which digital IC macros to use so the accelerator can clock-gate unused macros. Then, the accelerator starts to compute on the layer, which involves many iterations of three sub-tasks: input vector preparation, IC operation, and output quantization. Finally, it stores the layer output in the scratchpad and then interrupts the host. The host resumes executing the program.

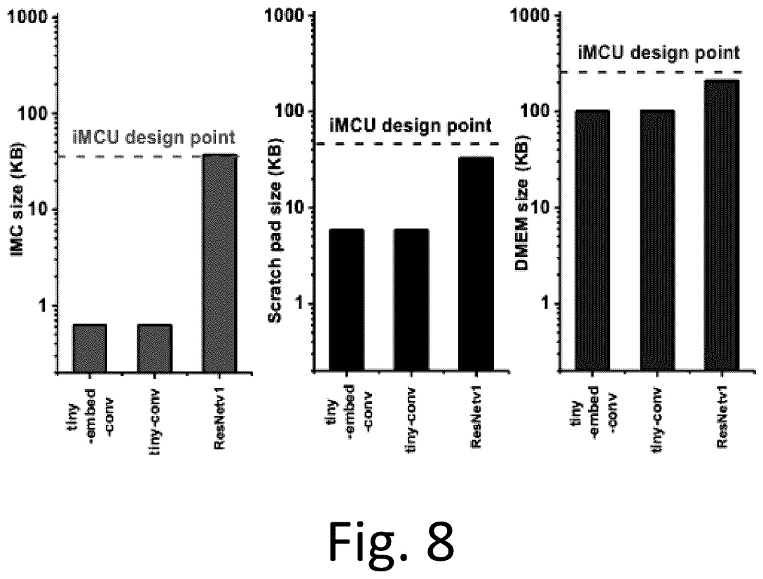

Based on the computation flow, the sizes of the memory blocks were determined, and the memory map was created (FIG. 8).

Again, the IC accelerator must buffer only one layer at a time. Therefore, the IMC size was set to be 32 KB, roughly matched to the largest layer of the target models. Similarly, the sizes of other memory blocks were determined. The largest model has 179 KB of weight data. Thus, the DMEM size was set to be 256 KB. The scratch pad was placed in the accelerator to fully buffer the output of one layer so that it can be used as the next layer's input. This helps to avoid costly DMEM accesses. The largest output data size is 32 KB, thereby setting the scratchpad size to 48 KB. Also, the size of AIEM was set to be 128 KB to store the largest program. The size of each memory is summarized in the memory map (FIG. 7).

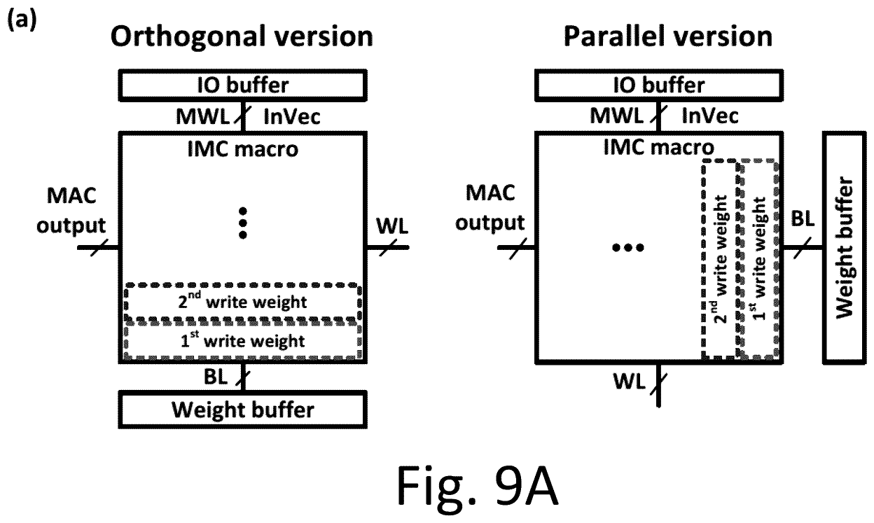

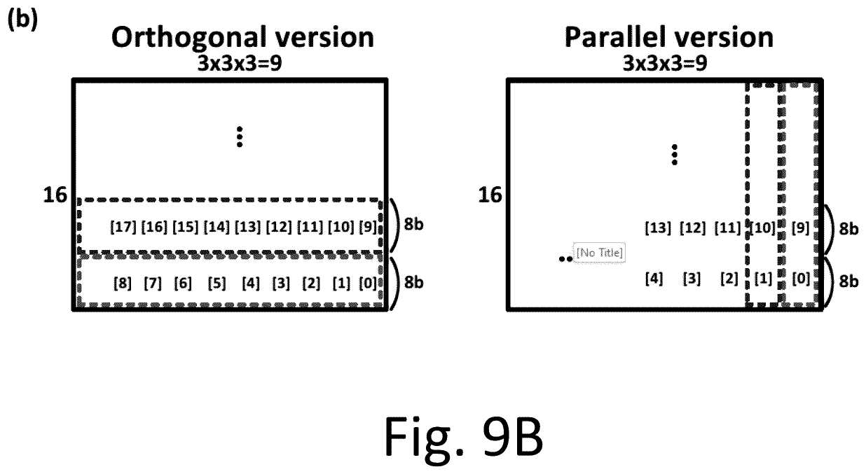

FIG. 9(a) shows the orthogonal and parallel versions of IMC. MWL is orthogonal to WL in the orthogonal version, while MWL is parallel to WL in the parallel version of IMC. For the orthogonal version, the DMA can be configured to write the data into IC with the same continuous address order as in the DMEM since the IO buffer and the weight buffer are in the same direction (FIG. 9(b)). However, it requires additional MAC BL to process the MAC results, increasing the area and power overhead. Therefore, the parallel version was adopted for improved performance. For the parallel version, there is an offset for writing the weight data from DMEM to IMC (FIG. 9(b)). This irregular address pattern makes transferring the data difficult for the DMA. To enable weight data movement in a continuous address from DMEM to IMC, a custom compilation method was developed that transposes the weight data offline before loading it into the DMEM.

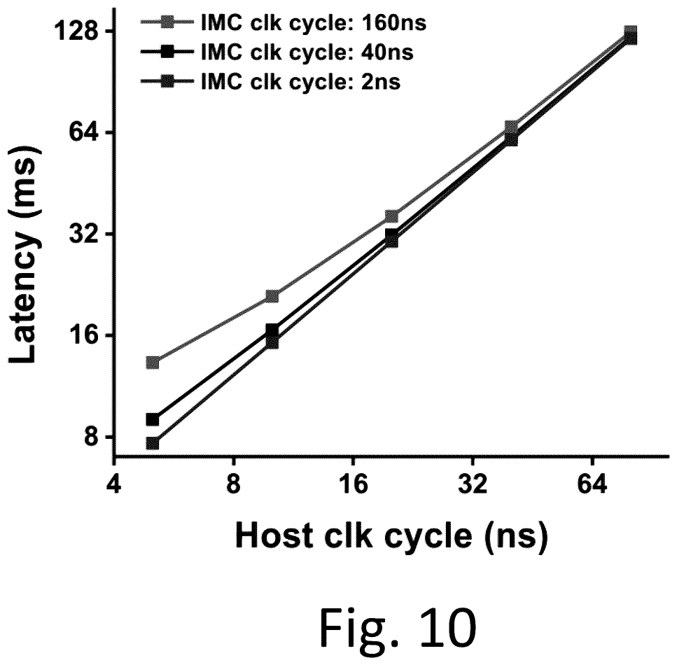

The impact of the latency was assessed with various IC local clock and host clock frequencies in FIG. 10. The host clock affects the overall latency seriously. After the IMC acceleration, other layers (average pooling and fully connected) and memory transfer and allocation, which operate under the host clock, dominate the overall execution time. On the other hand, the IC clock accounts for a small portion of the latency, having a negligible influence.

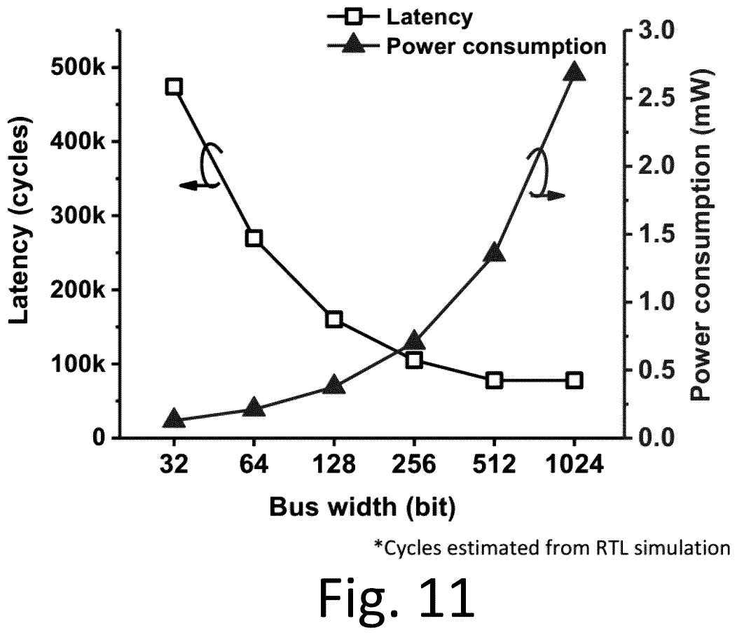

To assess the tradeoff on the bus, the bus widths were swept across from 32 b to 1024 b in FIG. 11. Higher bitwidth significantly reduces the weight transfer latency from DMEM to the IMC accelerator, improving the latency of convolution and addition layers by 6×. However, a wider bus increases the power consumption of the bus by 21×. Also, a wider bus can require an additional bus system because the host processor operates in 32 b. It can be optimized for a single 32 b bus to achieve better area and power efficiency.

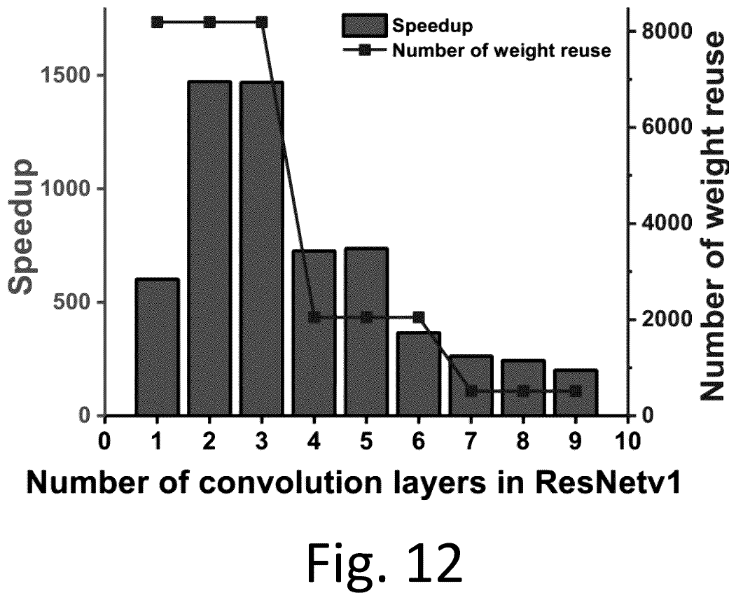

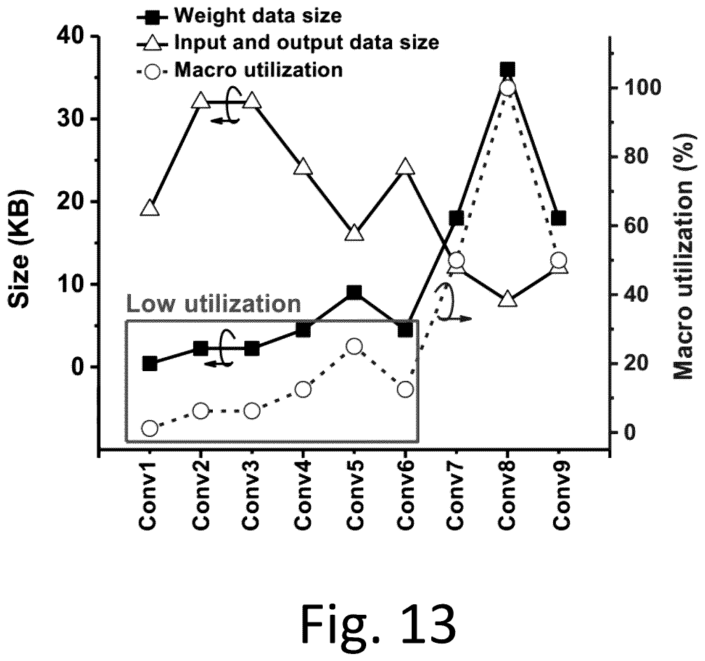

FIG. 12 details the speedup with the digital IC accelerator compared with the software baseline. Layer 1-5 achieves a better speedup than layers 6-9 because iMCU achieves a maximum acceleration for those layers with smaller weight data sizes and larger input/output data sizes (FIG. 13). Layers with larger input/output data sizes reuse the same weights more times, providing higher efficiency with the acceleration. Layers with larger weight data sizes and smaller input/output sizes require more weight data transfer from DMEM and compute the weights fewer times.

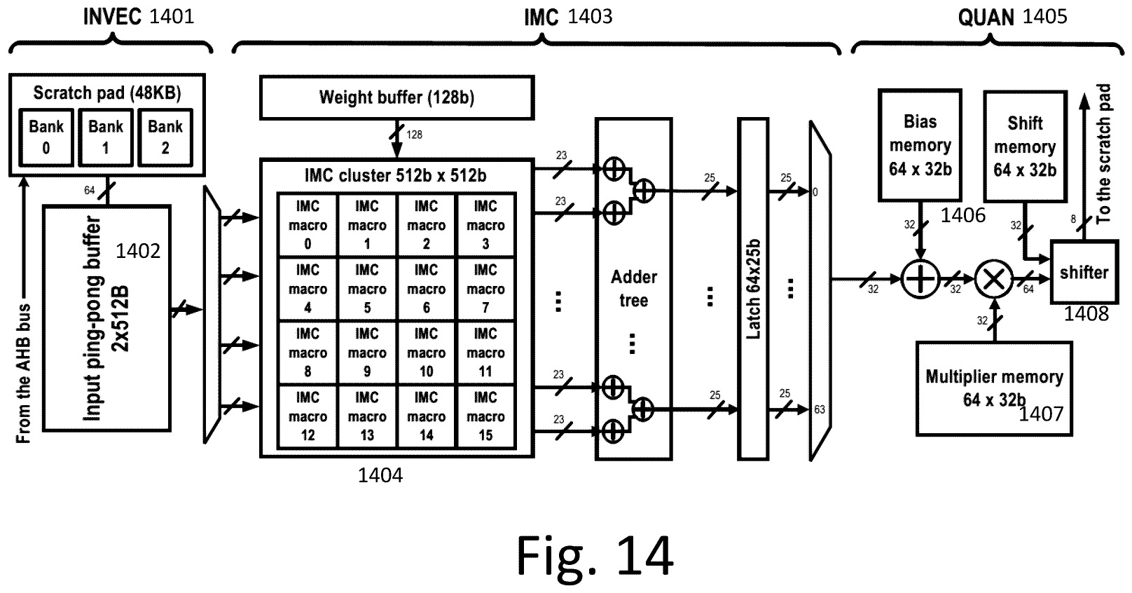

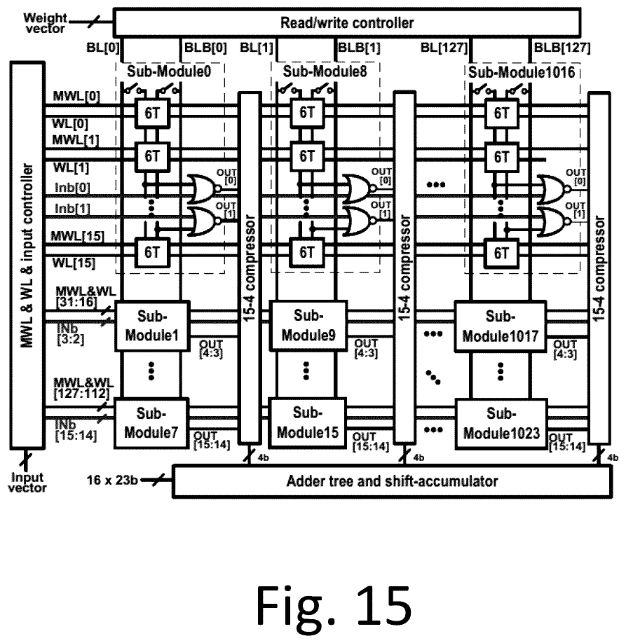

IMC Accelerator Architecture: the microarchitecture of the IC accelerator was devised to support the computation flow in a fully-pipelined manner (FIG. 14). It has three stages, each designed to take the same 64 cycles for the fully-pipelined operation. The first stage (INVEC) 1401 prepares input vectors and feeds them to the next stage. It employs two 512B buffers operating in a ping-pong fashion to hide the latency 1402. One buffer grabs 8B data per cycle from the scratchpad over 64 cycles. In parallel, the other buffer feeds an input vector, again 8B per cycle, to the IC macro cluster. The second stage (IMC) 1403 performs VMM using the 4×4 IMC macro cluster 1404. The cluster can complete one multiplication between an 8 b 512d (dimension) vector and an 8 b 64×512d matrix in 64 cycles. The last stage (QUAN) 1405 performs the quantization. The IMC stage's result can have up to 25 bits, but they can be quantized to 8 b before storing them in the scratchpad. Simply removing the LSBs is not optimal for inference accuracy. Instead, a quantization scheme was adopted from TFLite-micro, where the quantized value q is defined as:

q=2ⁿ·M₀·(r+Z)

where n, M₀₇, and Z are offline-computed hyperparameters, and r is the IMC stage's result. To quantize a 64d vector in 64 cycles, QUAN employs only one 2-input 32 b adder 1406, one 2-input 64 b multiplier 1407, and one 32 b-shifter 1408.

To support the layers where the weights cannot fit into the IMC cluster, the computation and generating partial sums, which can be configured into biases (Table I) for the next run and stored in the bias memory, were performed. After the new weights were loaded and start the next run, the final results are combined in QUAN.

TABLE I
CONFIGURATION REGISTER BITS IN IMC ACCELERATOR.

| Name | Description | Bitwidth |
|---|---|---|
| en_cpu_access | Enable cpu to read or write data | 1 b |
| Start: clk_sel | Select: no clock, clock from cpu, | 2 b |
| | IMC local clock | |
| sel_input_addr | Select the address where input data is | 2 b |
| | stored | |
| sel_output_addr | Select the address where output data | 2 b |
| | is stored | |
| output_partial_sum | Output is the partial sums of the next | 1 b |
| | computation | |
| bias_partial_sum | Bias is the partial sums of the next | 1 b |
| | computation | |
| ack_layer_done | Acknowledgement of the interrupt | 1 b |
| compute_add_layer | Enable executing add layer | 1 b |
| imc_macro_usage | Indicate which IMC macros are used | 16 b |

Digital IMC Macro: a digital IC macro was designed to maximize the robustness while trying to reduce the area overhead of digital circuits (FIG. 15). To do so, a timesharing architecture was adopted and improved, where the macro employs 128×128 compact 6 T bitcells to store the NN weights. Every eight bitcells share two multiplication units, which are implemented as NOR gates, and every 128×8 bitcells timeshare a set of compressors and an adder tree, which results in an excellent weight density of 126 KB/mm². The macro achieves the improved compute density of 1.25 TOPS/mm² at 1V and an energy efficiency of 40.16 TOPS/W at 0.6V with a 25% input toggle rate. After the inverted inputs perform multiplication with the inverted weights, the results of one column are fed into a compressor to produce the compressed results. The 15-4 compressor can convert 15 unweighted (2⁰) bits into weighted (2⁰-2³) bits. The adder tree and shift-accumulator take the partial sums and accumulate in a bit-serial manner for 8 b input and 8 b weight. Fully digital circuits, including compressors and adders, were used to ensure high robustness over PVT variations.

Clock Gating: In the course of performing an end-to-end inference, the accelerator needs to be active only for a part of the time. Take ResNetv1, for instance, most of the layers utilize less than 50% of the total macros (FIG. 13). To save the clock power consumption, a local clock generator which on-demand produces the clock signal for the accelerator when a task is given to the accelerator was embedded. The host sets the Start bit (Table I) in the configuration register file to enable the clock generator. When the accelerator completes a given task, it resets the Start bit to stop the clock. This on-demand clock generation eliminates unnecessary clock power waste.

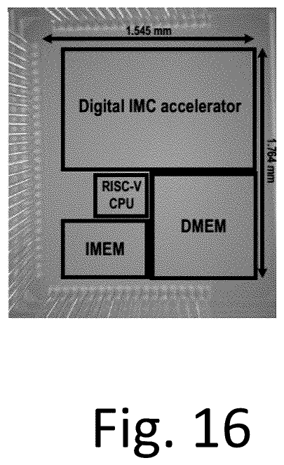

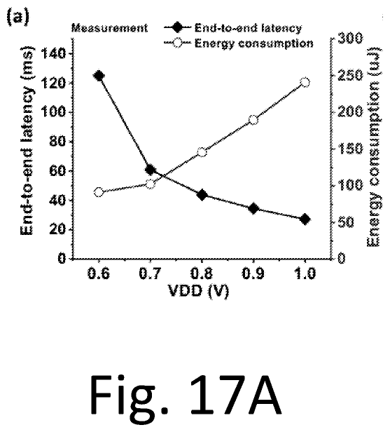

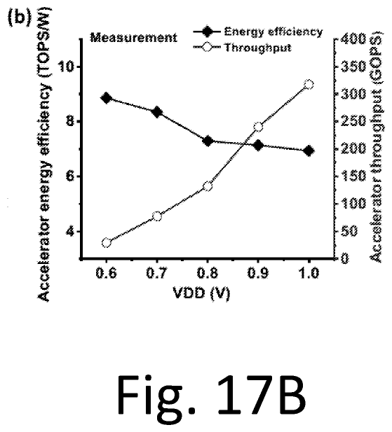

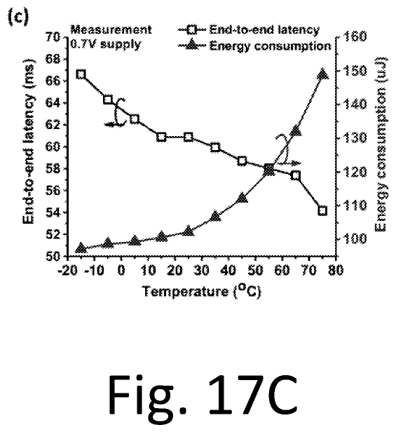

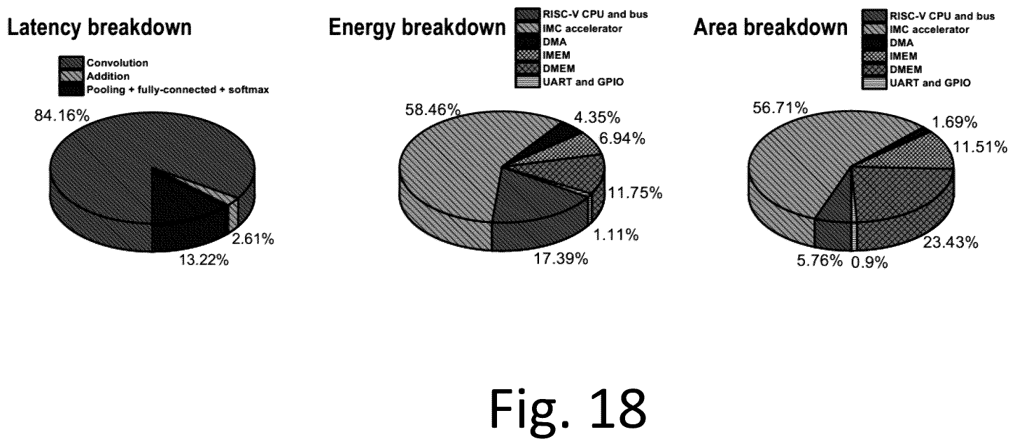

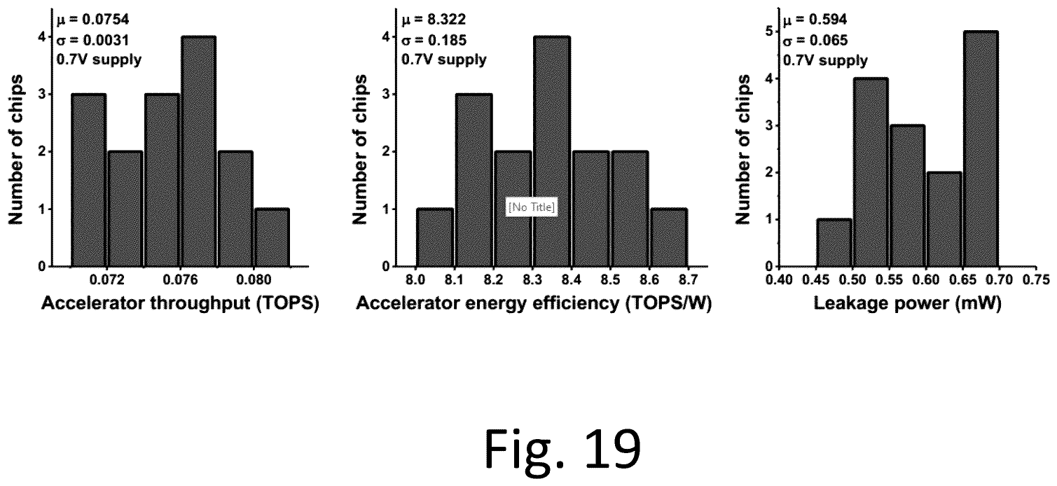

IMCU Testchip and Measurement Results: iMCU was formed in a 28 nm. It takes 2.73 mm² (FIG. 16). iMCU can perform an end-to-end inference with various TinyML models. For ResNetv1, it takes 60.9 ms and consumes 102.18 μJ per inference at 0.7V (FIG. 17(b)). The 8 b additions and multiplications that the IMC macros execute were counted and divided with the total energy consumption of the digital IMC accelerator, which gives the energy efficiency FoM of 8.86 TOPS/W (FIG. 17(b)). FIG. 18 shows the latency, energy, and area breakdown. FIG. 19 shows the maximum accelerator throughput, accelerator energy efficiency, and leakage power across 15 dies at 0.7V supply. The end-to-end latency and energy consumption were measured for one image classification inference across different temperatures from −15° C. to 75° C. in FIG. 17(c).

TABLE II
PERFORMANCE COMPARISON WITH STATE-OF-THE-ART MCUS.

| | | | | syntiant-9120-1v1- | xG24-DK2601B | NUCLEO-H7A3ZI-Q |
|---|---|---|---|---|---|---|
| | This work | JSSC20 [1] | ISSCC19 [3] | 98 mhz Syntiant [6] | Silicon Labs [6] | STMicroelectronics [6] |
| Technology | 28 | 65 | 28 | n/a | n/a | n/a |
| [nm] | | | | | | |
| Host | RISC-V 32b | RISC-V 23b | Cortex-M0 | HiFi3 + Cortex-M0 | Cortex-M33 32b | Cortex-M7 32b |
| processor | | | 32b | 32b | | |
| Accelerator | Digital IMC | Analog IMC | Digital IMC | Digital | Digital | n/a |
| | | | | accelerator | accelerator | |
| Activation | 8 | 1-8 | 1-32 | 1-16 | 8 | 32 |
| precision | | | | | | |
| [bit] | | | | | | |
| Weight | 8 | 1-8 | 1-32 | 1-16 | 8 | 32 |
| precision | | | | | | |
| [bit] | | | | | | |
| IMEM size | 128 KB | 128 KB | 16 KB | n/a | 1.5 MB⁵⁾ | 2.06 MB³⁾ |
| DMEM size | 256 KB | 128 KB | 16 KB | 304 KB | 256 KB | 1.4 MB |
| IMC size | 32 KB | 73.75 KB | 96 KB | n/a | n/a | n/a |
| In- | 48 KB | 0 KB | 0 KB | 1024 KB | n/a | n/a |
| accelerator | | | | | | |
| scratchpad | | | | | | |
| size | | | | | | |
| TOTAL | 464 KB | 329.75 KB | 128 KB | 1328 KB | 256 KB | 1.4 MB |
| SRAM size | | | | | | |
| TOTAL | 0.933 | 4.626 | 1.225 | n/a | n/a | n/a |
| SRAM area | | | | | | |
| [mm²] | | | | | | |
| Total area | 2.03 | 8.56 | 1.85 | 7.75 | n/a | n/a |
| [mm²] | | | | | | |
| IMC density | 125.8 | 25.2 | 104.5 | n/a | n/a | n/a |
| [KB/mm²] | | | | | | |
| (Total | | | | | | |
| SRAM | | | | | | |
| size/total | | | | | | |
| SRAM area) | | | | | | |
| SRAM | 497.42 | 71.28 | 104.49 | n/a | n/a | n/a |
| density | | | | | | |
| [KB/mm²] | | | | | | |
| (Total | | | | | | |
| SRAM | | | | | | |
| size/total | | | | | | |
| SRAM area) | | | | | | |
| Supply | 0.6-1 | 0.85-1.2 | 0.6-1.1 | 0.9-1.1 | n/a | 0.74-1.3 |
| voltage [V] | | | | | | |
| Operating | 6-35 (host) | 40-100 | 114-475 | 30-98 | 40-78 | 280 |
| frequency | 29-310 | | | | | |
| [MH_{z}] | (accelerator) | | | | | |
| Macro | 1.25 | 0.0094 | 0.0273 | n/a | n/a | n/a |
| compute | (1 V, 8b, 8b) | (1.2 V, 8b, 8b)²⁾ | (1.1 V, 8b, 8b) | | | |
| density | | | | | | |
| [TOPS/W] | | | | | | |
| Macro | 40.16 | 6.25 | 0.56-5.27 | n/a | n/a | n/a |
| energy | (0.6 V, 8b, 8b)¹⁾ | (0.85 V, 8b, 8b)²⁾ | (0.6 V, 8b, 8b) | | | |
| efficiency | | | | | | |
| [TOPS/mm²] | | | | | | |
| Accelerator | 0.301 | 0.0094 | 0.0273 | n/a | n/a | n/a |
| compute | (1 V, 8b, 8b) | (1.2 V, 8b, 8b)²⁾ | (1.1 V, 8b, 8b) | | | |
| density | | | | | | |
| [TOPS/mm²] | | | | | | |
| Accelerator | 8.86 | 6.25 | 0.56-5.27 | n/a | n/a | n/a |
| energy | (0.6 V, 8b, 8b) | (0.85 V, 8b, 8b)²⁾ | (0.6 V, 8b, 8b) | | | |
| efficiency | | | | | | |
| [TOPS/W] | | | | | | |
| Accelerator | 0.318 | 0.0341 | 0.0327 | n/a | n/a | n/a |
| throughput | (1 V, 8b, 8b) | (1.2 V, 8b, 8b)²⁾ | (1.1 V, 8b, 8b) | | | |
| [TOPS] | | | | | | |
| FoM = acc. | 262.8 | 0.71 | 3.61 | n/a | n/a | n/a |
| Compute | (1 V, 8b, 8b) | (1.2 V, 8b, 8b) | (0.6 V, 8b, 8b) | | | |
| density × | | | | | | |
| acc. Energy | | | | | | |
| efficiency × | | | | | | |
| IMC density | | | | | | |
| Latency [ms] | 60.9 | n/a | n/a | 5.1 | 239.98 | 158.13 |
| Energy | 102.18 | n/a | n/a | 139.4 | 2248.02 | 4151.13 |
| Consumption | | | | | | |
| [uJ] | | | | | | |

¹⁾Simulated.
²⁾Normalized to 8b weights and 8b activations.
³⁾n/a: not available
⁴⁾The top-1 accuracy of all systems are above 85%, meeting the quality target in the benchmark suite.

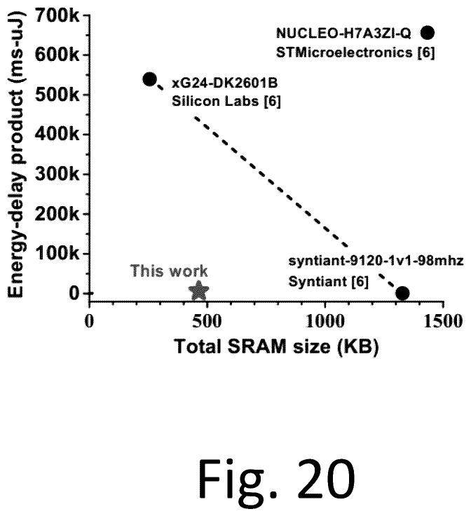

iMCU was compared with the recent TIC-based MCUs in Table 11. As compared to existing techniques, the disclosed iMCU achieves 73× better FoM=accelerator compute density×accelerator energy efficiency×IMC density. For 8 b input and 8 b weight, the disclosed IC accelerator achieves 11× better compute density and 1.7× higher energy efficiency. iMCU attains 5× greater SRAM density (including TIC SRAM and foundry SRAM) than existing techniques since iMCU utilizes the least amount of IMC hardware size and stores all the weights in dense foundry SRAM. The energy-delay product and SRAM size of state-of-the-art MCUs are shown in FIG. 20.

Computing-intensive VMM existing in TinyML models necessitates specialized hardware architecture to improve inference latency and energy consumption. Conventional digital accelerators suffer from limited throughput and energy efficiency during the data transfer between the memory and computing engines. IMC, therefore, has been proposed to tackle this challenge. However, existing works need a large amount of IC hardware, degrading the area efficiency. Also, their analog operations cause incorrect results over PVT variations. The disclosed subject matter provides iMCU that requires the least amount of IMC hardware but still gives a significant acceleration. The disclosed subject matter employs digital IC circuits to ensure correct inference results over PVT variations. Also, iMCU supports a practical software development framework and performs a standard benchmark suite MLPerf-Tiny. The disclosed subject matter in 28 nm CMOS demonstrates the accelerator energy efficiency of 8.86 TOPS/W. iMCU achieves 73× in the proposed FoM improvement. The disclosed improvements reduce the silicon area of iMCU down to 2.73 mm². The on-chip 432 KB foundry SRAM takes 0.678 mm², and the 32 KB IC SRAM takes 0.254 mm².

### Example 2: iMCU: A 102-μJ, 61-ms Digital In-Memory Computing-based Microcontroller Unit for Edge TinyML

TinyML can allow performing a deep neural network (DNN)-based inference on an edge device, which makes it paramount to create a neural microcontroller unit (MCU). Certain MCUs integrate in-memory computing (IMC) based accelerators. However, they employ analog-mixed-signal (AMS) versions, exhibiting limited robustness over process, voltage, and temperature (PVT) variations. They also employ a large amount of IMC hardware, which increases silicon area and cost. Also, they do not support a practical software dev framework such as TensorFlow Lite for Microcontrollers (TFLite-micro). Because of this, those MCUs did not present the performance for the standard benchmark MLPerf-Tiny, which makes it difficult to evaluate them against the state-of-the-art neural MCUs.

In this example, the disclosed subject matter provides iMCU, the IMC-based MCU in 28 nm, which outperforms the current best neural MCU (SiLab's xG24-DK2601B) by 88× in energy-delay product (EDP) while performing MLPerf-Tiny. Also, iMCU integrates a digital version of IMC hardware for maximal robustness. The acceleration targets and the computation flow can be optimized to employ the least amount of IMC hardware yet still enable significant acceleration. As a result, iMCU's total area is only 2.03 mm2 while integrating 433 KB SRAM and 32 KB IMC SRAM.

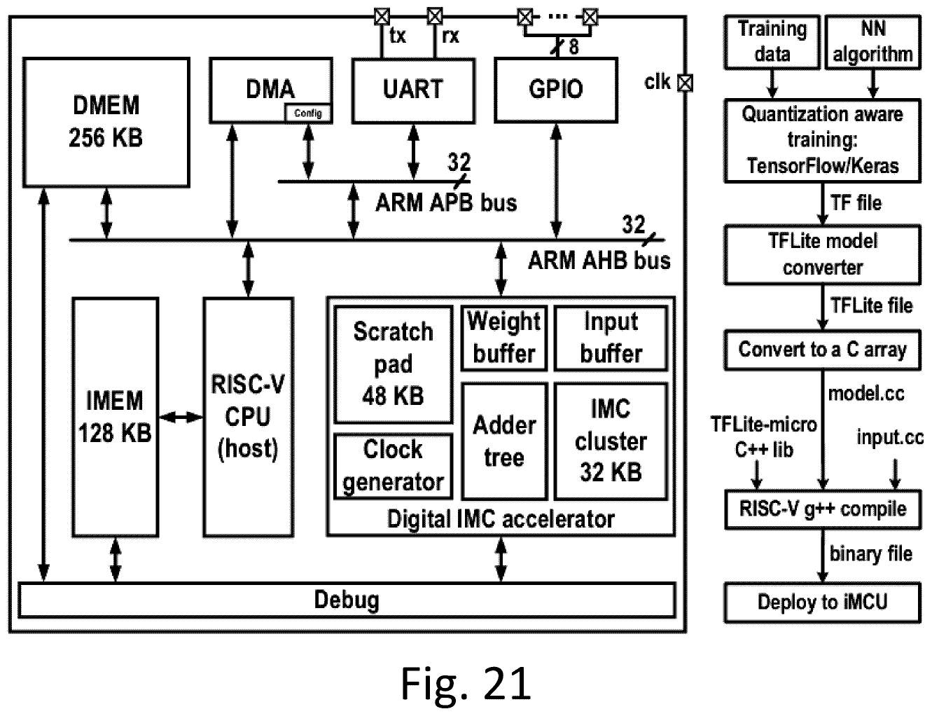

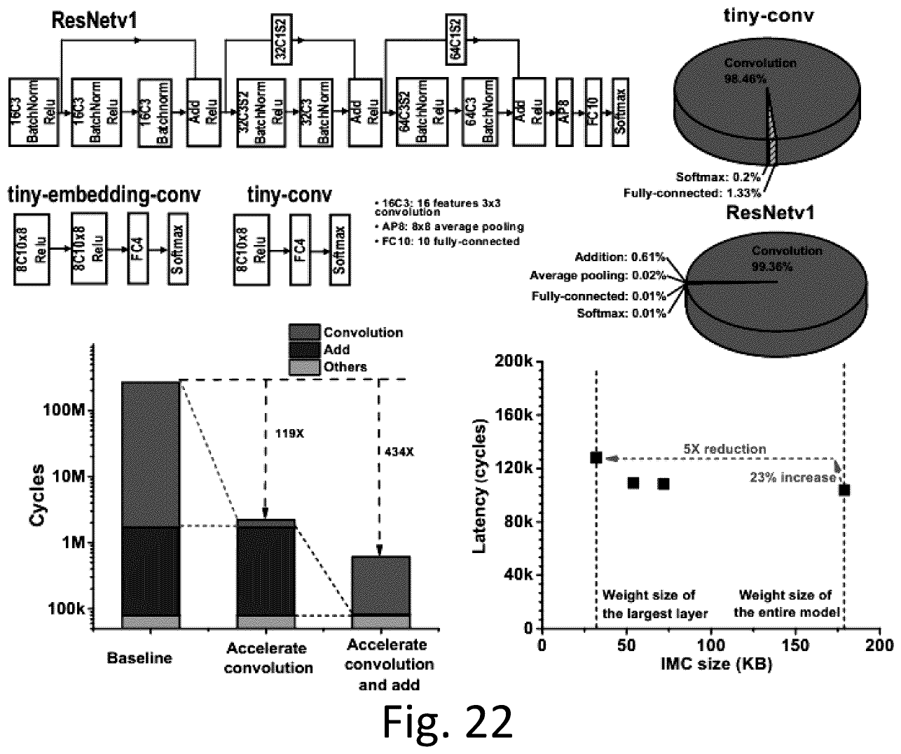

FIG. 21 left illustrates the overall organization of iMCU, which consists of i) a 32 b RISC-V CPU core (the host processor), ii) a digital IMC accelerator that contains the IMC cluster, iii) instruction memory (IMEM), iv) the main data memory (DMEM), v) direct memory access (DMA) module, vi) a universal asynchronous receiver-transmitter (UART), vii) a general-purpose IO (GPIO), and viii) a 32 b ARM AHB/APB bus. FIG. 21 right shows the matching software dev framework for iMCU, which is based on TFLite-micro. It starts with the training of an 8-b DNN model via TensorFlow, which produces a TF file. Then, the TF file can be converted into the TFLite file by fusing a batch norm layer into a convolution layer. This helps to avoid adding explicit hardware support for batch-norm-related computation. Then, the TFLite file can be converted to the C header file model.cc. Then, the header file can be compiled with the input data file (input.cc) and the TFLite-micro library file. To reuse the standard 6 T SRAM, the IMC hardware that has a parallel direction of WL and MWL was designed. However, this IMC orientation causes irregular weight data access, which complicates the DMA transfer since DMA has to access and transfer the data from noncontinuous addresses of DMEM. Therefore, a custom compilation method was developed to match the address sequence of weight data with the address sequence of the IMC weight update. The compilation produces the instruction and data hexadecimal files, which can be stored in IMEM and DMEM, respectively. Using the framework, the software was developed for the following DNN models, tiny-cony, tiny-embedding-cony, and ResNetv1 (FIG. 22 top left).

iMCU was designed by determining which layers are worth accelerating. The accelerator supports only those layers to reduce the area overhead. The complexity of each layer was profiled using SPIKE. The convolution layer can be the most dominant, followed by the addition layer (FIG. 22 top right). If convolution layers are accelerated by 500×, the estimated total cycle count can be reduced by 119×. If the addition layers are accelerated, an additional 3.6× speed-up (total 434×) can be gained (FIG. 22 bottom left). All the other layers (pooling, fully connected, softmax) are not worth accelerating since it provides only a negligible cycle count reduction.

Then, the computation flow (sequence) that requires the least amount of IMC hardware yet still provides a significant acceleration was revised. Existing works employ arbitrarily large amounts of IMC hardware to store more than one (sometimes all) layer of weight data of a DNN model before starting computation. Such architecture, however, severely increases area overhead. Here, an alternative computation flow was devised where the main data memory (DMEM), implemented in the dense foundry 6 T bitcells, stores all the weights, and the IMC hardware buffers the weight data of only one layer right before the accelerator computes on the layer. While the disclosed flow increases data movement cost between the main memory and the IMC accelerator, the area savings largely outweigh the IMC hardware's area reduced by 5× while the cycle count increases by only 23% (FIG. 22 bottom right). This is because 100-10,000 VMMs were performed for each layer, thereby amortizing the data movement cost over many VMMs.

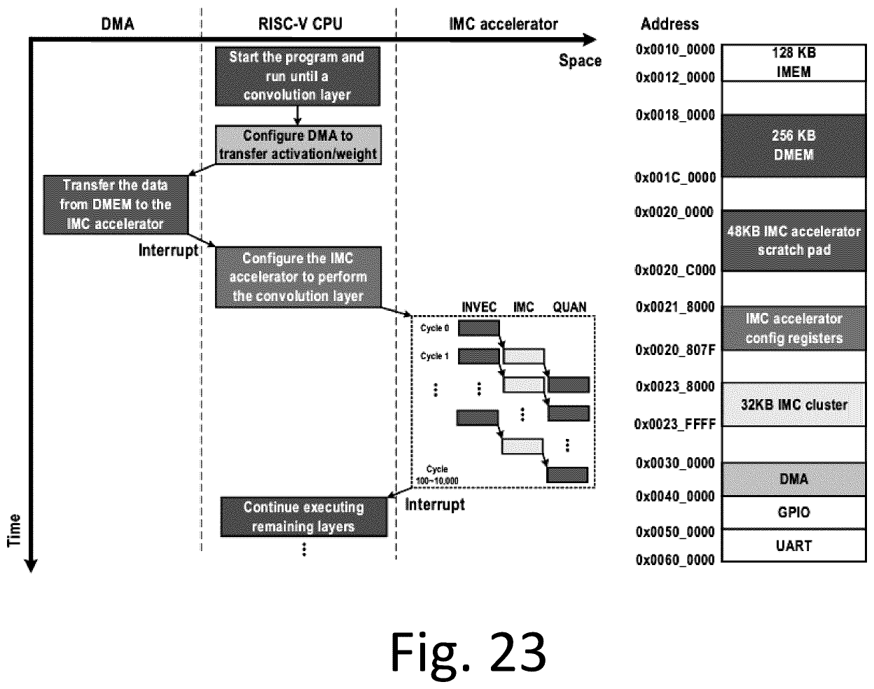

FIG. 23 left shows the proposed flow for an end-to-end inference. The host starts the program, and as it reaches a convolution (or an addition) layer, it configures DMA to transfer the weight data of that layer from DMEM to the IMC cluster; and only for the input layer, DMA transfers the input data from DMEM to the scratchpad. Then, the host configures layer-related parameters such as dimensions of input, filter, and output, stride and padding sizes, input and output offsets, and the starting addresses of the input, weight, output data accesses, etc. Also, the host configures which digital IMC macros to use and clock-gate unused macros. Then, the accelerator starts to compute on the layer, which involves many iterations of three sub-tasks, namely input vector preparation, IMC operation, and output quantization. Finally, it stores the output of the layer in the scratchpad and then interrupts the host. The host resumes the program.

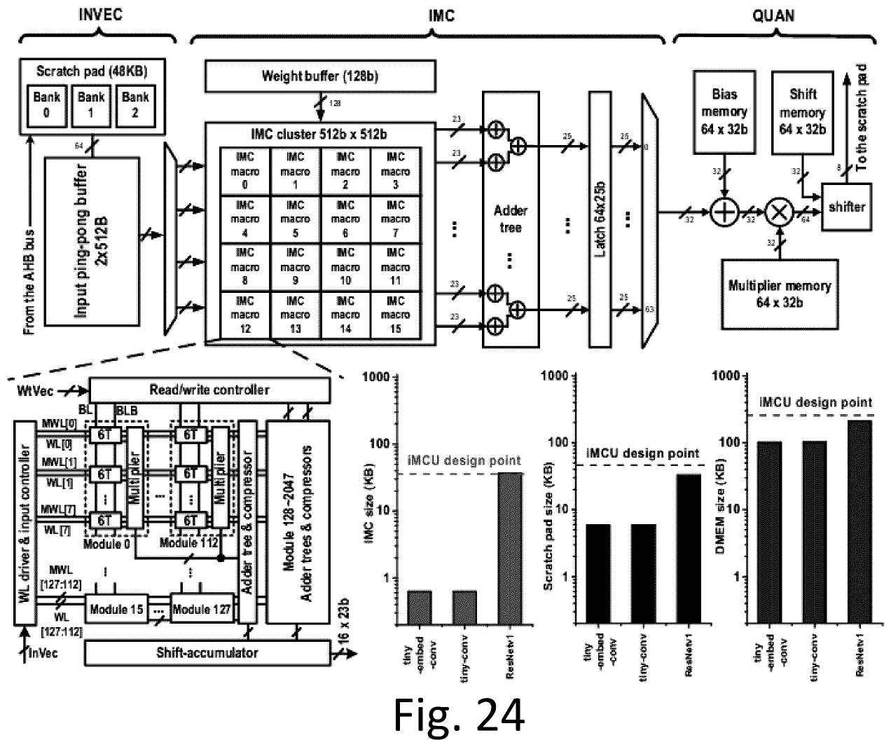

Based on the computation flow, the sizes of the memory blocks were determined, and the memory map was created (FIG. 24 bottom right). Again, the IMC accelerator requires to buffer only one layer at a time. Therefore, IMC size was set to be 32 KB, roughly matched to the largest layer of the target models. Also, the largest model has a total of 179 KB of weight data. Thus, the main data memory (DMEM) size was set to be 256 KB. To place the scratch pad in the accelerator to fully buffer the output of one layer such that it can be used as the input of the next layer, the scratchpad size was set to be 48 KB, matched to the largest output data size. Also, the IMEM is set to be 128 KB to store the largest program. (FIG. 23 right).

In this example, the fully-pipelined IMC accelerator was designed (FIG. 24 top). It has three stages, and each stage takes the same 64 cycles. The first stage (INVEC) prepares input vectors and feeds them to the next stage (IMC). It employs two 512B buffers operating in a ping-pong fashion to hide the latency. The second stage (IMC) performs VMM using the 4×4 IMC macro cluster. The cluster can complete one multiplication between an 8 b 512d vector and an 8 b 64×512d matrix in 64 cycles. The last stage (QUAN) performs the quantization. The IMC stage's result can have up to 25 bits, but needs to quantize to 8 b before storing them in the scratchpad. Simply removing the LSBs is not optimal for inference accuracy. Instead, the quantization scheme of TFLite-micro was used, where the quantized value q is defined as Q=2n·M0·(r+Z), where n, M0, Z are offline-computed hyper-parameters and r is the IC stage's result. QUAN needs to quantize only one 64d vector in 64 cycles. Therefore, it employs only one 2-input 32 b adder, one 2-input 64 b multiplier, and one 32 b shifter. The accelerator can still support a layer that is larger than the IC cluster. It can produce partial sums with partial weight data and combine them to produce the final result.

A digital IMC macro was designed to maximize the robustness while trying to reduce the area overhead of digital circuits (FIG. 24 bottom left). To do so, a time-sharing architecture was adopted and improved, where the macro employs 128×128 compact 6 T bitcells. Every eight bitcells time-share one multiplier, and every 128×8 bitcells time-share a set of compressors and an adder tree, which results in an excellent weight density of −126 KB/mm2. The macro achieves an excellent compute density of 1.25 TOPS/mm2 at 1V and an energy efficiency of 40.16 TOPS/W at 0.6V with a 25% input toggle rate.

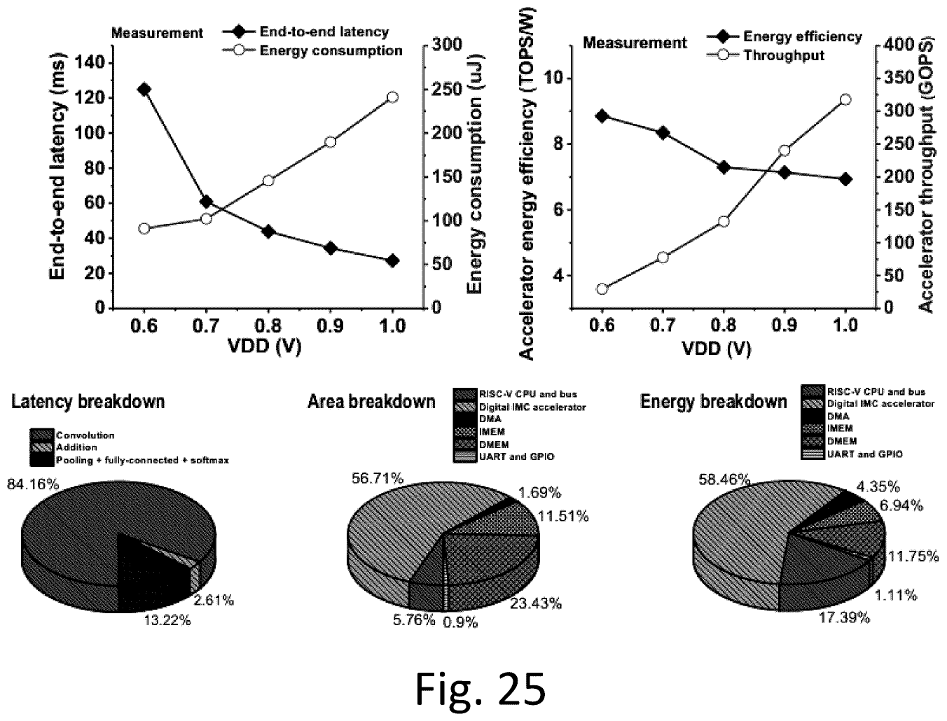

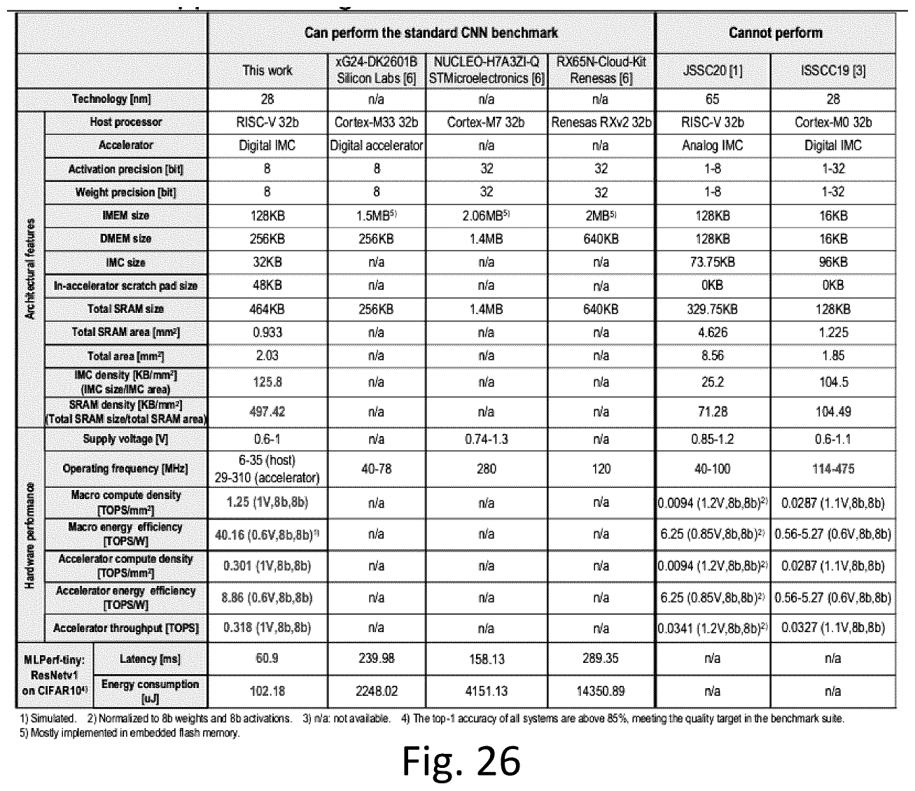

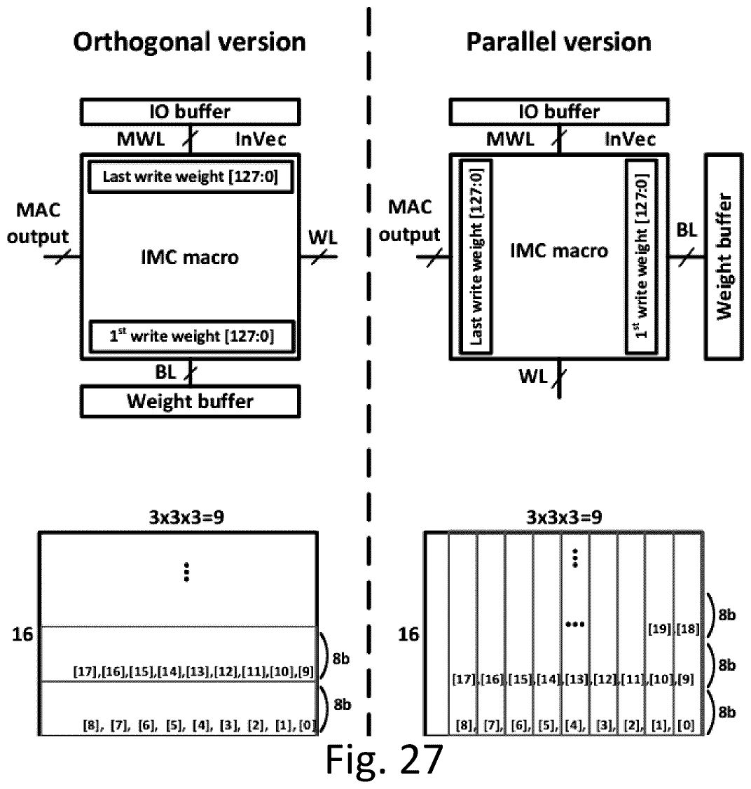

iMCU was produced in a 28 nm. To evaluate against the state-of-the-art neural MCUs, iMCU executed the standard benchmark, ResNetv1, from MLPerf-Tiny. It takes 60.9 ms and consumes 102.18 μJ per inference (FIG. 25 top left). This marks 88× EDP improvement (22× in E and 3.94× in D) over the best neural MCU (SiLab's xG24-DK2601B). FIG. 25 bottom shows the area, energy, and delay breakdown. iMCU is fully digital hardware and produces the correct computation results across PVT variations. The disclosed improvements reduce the silicon area of iMCU down to 2.73 mm2. The on-chip 432 KB foundry SRAM takes 0.678 mm2, and the 32 KB IMC SRAM takes 0.254 mm2 (FIG. 26).

The present disclosure is well adapted to attain the ends and advantages mentioned as well as those that are inherent therein. The particular embodiments disclosed above are illustrative only, as the present disclosure can be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above can be altered or modified, and all such variations are considered within the scope and spirit of the present disclosure.

What is claimed is:

1. A microcontroller unit for computing performance, comprising
a central processing unit (CPU) configured to start a computing program;
an accelerator comprising an in-memory computing (IMC) macro cluster configured to accelerate at least one layer of a machine learning model;
a data memory (DMEM); and
a direct memory access (DMA) module configured to transfer a weight data of a layer of a machine learning model from the DMEM to the IMC macro cluster.

2. The microcontroller unit of claim 1, wherein the accelerator comprises a microarchitecture configured to support a fully pipelined operation.

3. The microcontroller unit of claim 2, wherein the microarchitecture of the accelerator comprises a first stage, a second stage, and a third stage.

4. The microcontroller unit of claim 1, wherein the first stage is configured to prepare an input vector and feed it to the second stage, wherein the first stage is configured to employ buffers operating in a ping-pong fashion to hide a latency.

5. The microcontroller unit of claim 4, wherein the second stage is configured to perform a vector-matrix multiplication (VMM) using the IMC macro cluster, wherein the IC macro cluster is configured to complete a multiplication in 64 cycles.

6. The microcontroller unit of claim 5, wherein the third stage is configured to perform quantization based on results from the second stage.

7. The microcontroller unit of claim 2, wherein the IMC macro cluster comprises a timesharing architecture, where the IMC macro cluster comprises 6 T bitcells, wherein the 6 T bitcells are configured to share multiplication units.

8. The microcontroller unit of claim 1, wherein the IMC macro cluster comprises a lock clock generator, wherein the lock clock generator is configured to produce a clock signal for the accelerator when a task is given to the accelerator, when the accelerator completes the task, the lock clock resets a start bit to stop the clock.

9. The microcontroller unit of claim 1, wherein the DMEM is implemented in foundry 6 T bitcells and configured to store all weight data.

10. The microcontroller unit of claim 1, wherein the microcontroller unit is an in-memory computing (IMC) based microcontroller unit.

11. The microcontroller unit of claim 1, further comprising
an instruction memory (IMEM);
a universal asynchronous receiver-transmitter (UART) [UART];
a general-purpose IO (GPIO); and
a bus.

12. The microcontroller unit of claim 1, wherein a size of the IMC size is up to 32 KB.

13. The microcontroller unit of claim 1, wherein a size of the in-accelerator scratch pad is up to 48 KB.

14. The microcontroller unit of claim 1, wherein a total area of the microcontroller unit is less about 2.03 mm².

15. A method for producing a software framework, comprising
producing a TensorFlow (TF) file by training a deep neural network (DNN) model;
converting the TF file into a TensorFlow Lite (TFLite) file and fusing a batch norm layer of the DNN model into a convolution layer;
converting the TFLite file to a C header file;
producing an instruction file and a data hexadecimal file by compiling the C header file with an input data file and a TFLite-micro library file; and
producing a software for the DNN model using the instruction file and the data hexadecimal file.

16. The method of claim 15, wherein the DNN model is a 8-b DNN model.

17. The method of claim 15, wherein the instruction and the date hexadecimal file are stored in IMEM and DMEM.
